(19) United States
(12) Patent Application Publication
(10) Pub. No.: US 2024/0020956 A1
(43) Pub. Date: Jan. 18, 2024

(54) ARTIFICIAL INTELLIGENCE CAMERA FOR VISUAL INSPECTION WITH NEURAL NETWORK TRAINING ONBOARD

(71) Applicant: DeepView Corp., Macomb, MI (US)

(72) Inventor: Eliyahu Davis, Macomb, MI (US)

(73) Assignee: DeepView Corp., Macomb, MI (US)

(21) Appl. No.: 18/254,596

(22) PCT Filed: Nov. 18, 2021
(86) PCT No.: PCT/US21/59974

§ 371 Date: May 25, 2023

Related U.S. Application Data
(60) Provisional application No. 63/118,607, filed on Nov. 25, 2020.

(51) Int. Cl. G06V 10/774; G06V 10/82; G06V 20/70; G06V 10/94; G06T 7/00; G06V 10/776

(52) U.S. Cl. CPC G06V 10/774; G06V 10/82; G06V 20/70; G06V 10/945; G06T 7/0004; G06V 10/776; G06T 2200/28; G06T 2207/20081; G06T 2207/20084; G06T 2200/24; G06T 2207/30108; G06T 2207/20092

(57) ABSTRACT

A system and method for performing visual part inspections are described herein. The system uses an imaging device in conjunction with at least one image recognition neural network to identify characteristics of parts by way of their images, training the system either during part inspection or not during part inspection to better recognize these characteristics.

### CROSS-REFERENCE TO RELATED APPLICATIONS

This application claims priority from PCT Application No. PCT/US21/59974, which claims priority from U.S. Provisional Application No. 63/118,607, which is incorporated herein by reference in its entirety.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### FIELD

The present teachings relate to systems and methods for inspecting parts that originate from a manufacturing, engineering, industrial or logistical setting.

### INTRODUCTION

The computer hardware needed to train a neural network has historically been too size prohibitive to be deployed in an end product (e.g. an imaging device). This is because it takes much more computational power to train a neural network than to run a neural network once it has been trained.

However, with enough computer hardware, and the correct software, it is possible to train a neural network directly on one end product or device. Taken further, the neural network can be trained in real time as the neural network is interacting with its environment.

Specific to parts, to have a system that, during part inspection or in real time, is capable of capturing images of parts while training a neural network to recognize and inspect passable and non-passable parts, all of which occurs onboard the end product, would be greatly beneficial. In addition, a system that has the flexibility of training an image recognition neural network during part inspection (in real time) and not during part inspection (not in real time) is valuable.

### SUMMARY

The present teachings include a system for performing a visual inspection of a part as part of one of a manufacturing, engineering, logistical, and industrial process, the system comprising an imaging device, computer hardware in communication with the imaging device, computer software executed by the computer hardware, and at least one image recognition neural network configured to train onboard the computer hardware. The part inspection may take place in one of a manufacturing, engineering, industrial, or logistical setting. The hardware is in logical communication with the imaging device, and the software is executed by the hardware. The at least one image recognition neural network is configured to train onboard the computer hardware with the purpose of inspecting parts. In an embodiment, the at least one image recognition neural network is configured to not train onboard the computer hardware. In another embodiment, the system may be used to inspect multiple different parts, all on a single manufacturing production line. In another embodiment, the system may inspect different parts on multiple production lines. In another embodiment, the system may inspect different parts for differing areas of interest on the parts. For instance, the system may inspect both steel and aluminum on a single production line.

In accordance with a further aspect, the systems stores at least one image and at least one image label. A user may have access to a storage repository or database of all images, image labels, and image recognition neural networks, all onboard the computer hardware.

In accordance with yet another aspect, the system comprises a user interface. In an embodiment, the user interface is accessible via a web browser. In another embodiment, the user interface is visualized on a virtual reality device. In another embodiment, the user interface is visible on a 2D screen. In another embodiment, the user interface is visualized on a holographic display. In another embodiment, the user interface is visualized through a mixed reality device. The user interface is user accessible for accessing all images, image labels, and image recognition neural networks onboard the computer hardware. In an embodiment, the user interface and system are integrated into one component. In another embodiment, the user interface and the system are separate entities.

In accordance with yet a further aspect, the system further comprises a communications interface to a digital communications device that sends the system a request to capture an image or images, and to which the system reports inspection results. In one embodiment, the digital device is a Programmable Logic Controller (PLC) on a manufacturing production line. In another embodiment, the device is a local server. In another embodiment, the device is an internet server.

In accordance with yet another aspect, the user interface allows a user to manipulate the at least one image and the at least one image label.

In accordance with yet another aspect, the at least one image recognition neural network may be trained for use during part inspection and not during part inspection. Essentially, the at least one image recognition neural network may be trained in real time and not in real time. For training in real time, the system may train at least one image recognition neural network during production or part inspection, onboard the system's hardware. As an example, a user, after inspecting the contents of an image of a part, may mark the image as pass or fail (passable or non-passable), and this image is used to train the image recognition neural network. For training not in real time, the computer hardware integral to the system may function in the role traditionally fulfilled by a neural network training server. In the conventional approach the neural network training server is decoupled from the part inspection system; the neural network training server is traditionally decoupled from the part inspection system because the computer hardware requirements of training an image recognition neural network are typically orders of magnitude greater than the computer hardware requirements of running that same neural network once it has been trained to recognize images. In contrast, this system is specified with computer hardware capable of fulfilling the role traditionally played a neural network training server. In essence, neural network training and neural network inference (in this instance, part inspection) are being integrated into a single system in a way previously not attempted. For training that does not happen during production, the at least one image recognition neural network trains once production is done.

In accordance with yet another aspect, the at least one image, the at least one image recognition neural network, and the at least one image label are stored on the system's computer hardware.

In accordance with yet another aspect, a user may inspect the at least one image to make a determination regarding the at least one image. In an embodiment, the user may inspect the contents of the at least one image. In another embodiment, the user may inspect an area of interest of the at least one image.

In accordance with yet another aspect, the system uses feedback from the user to train the at least one image recognition neural network on the at least one image. In an embodiment, the at least one image recognition neural network is trained to better recognize areas of interest in the at least one image. In another embodiment, the at least one image recognition neural network is trained to better recognize the contents of the at least one image.

The present teaching also include a method for training an image recognition neural network for part inspection, comprising capturing at least one image with an imaging device; inspecting the at least one image with at least one image recognition neural network; reporting inspection results to a user interface; via the user interface, soliciting user feedback based on at least one of contents of the at least one image and inspection results; receiving the user feedback; updating internal weights of the at least one image recognition neural network based on the user feedback (i.e. training the network directly from the data received from the users' feedback); and optionally reviewing and validating an image recognition neural network weight update that occurs based on at least one of solicitation of the system and receipt of user feedback.

The present teachings also include a method for training an image recognition neural network, the method comprising selecting at least one image used to train the image recognition neural network by at least one of uploading the at least one image and selecting the at least one image from a group of images stored onboard the system via a user interface; optionally identifying an area of interest within the at least one image; soliciting a user to apply at least one label to the at least one image via the user interface; splitting the at least one image and the at least one label into at least one of a training subset comprised of images and image labels and a test subset comprised of images and image labels; soliciting neural network training parameters from the user via the user interface; from the least one image provided by the user and the at least one label comprising the training subset and neural network training settings, instantiating an image recognition neural network and consequently updating neural network weights based on contents of the training subset; via the user interface, allowing the user to monitor neural network training progress as it occurs, displaying relevant training statistics on the user interface, with the training statistics being a reflection of how well the image recognition neural network is performing on the test subset; and following the neural network training, displaying via the user interface results of the neural network training on the test subset of images and labels and displaying to the user predictions of the image recognition neural network of the test subset, including confidence scores ranging from 0 to 100%. These confidence scores are representation of the neural network's degree of certainty as to the accuracy of its predictions. The system trains the image recognition neural network on the training subset of images and labels, while periodically evaluating the same image recognition neural network based on how well it performs on the test subset. The test subset is not used for training; the test subset is only used for evaluation. A user provides feedback to the system, as well as reviews and validates the at least one image recognition neural network. During training of the at least one image recognition neural network, its ability to accurately identify the contents of an image is controlled by the adjustment of neural network weights, which strengthen or diminish interneuron communication signal strength. In an embodiment, an image that is captured by the imaging device is converted into a 3D matrix of pixel values. In an embodiment, the image is a 1280×960 image in which the 3D matrix would be 1280×960×3, the first dimension being width of the image, second dimension being height of the image, and third dimension being for each of the red, green, blue color channels. In another embodiment, the image is a grayscale image; the grayscale may be represented by a 3D matrix of 1280×960×1 in which the single channel is the grayscale pixel values; alternatively, for convenience, the same 3D matrix as the 1280×960×3 3D matrix used for color, in which the three color channels are all identical grayscale pixel values. The latter approach allows greater commonality between grayscale and color image recognition networks. The at least one image recognition neural network may be trained on multiple images for each network weight update. Inspection results reported to a user may be when all images have been trained by the image recognition neural network, producing training statistics, which may include false positives and false negatives. Following training, images with their confidence threshold are displayed on the user interface. The at least one image recognition neural network may be adjusted to arrive at more accurate determinations

In accordance with a further aspect, the method is a part of an inspection process.

In accordance with yet another aspect, the contents of the at least one image varies. In an embodiment, the contents of the at least one image may be an imperfection in the part. In another embodiment, the contents may be a nonconformity. In another embodiment, the contents may be a barcode. In another embodiment, the contents may be a data matrix. Any feature of the at least one image that a user would like to inspect may be the contents.

In accordance with yet another aspect, the predictions of the at least one neural network is mapped onto the at least one image. In an embodiment, a 2D box is drawn around the area of the image of the neural network predictions. In another embodiment, a 3D box is drawn around the area of the image of the neural network predictions. In another embodiment, the area of the image of the neural network predictions is highlighted with a translucent color, such as red or green, through which the area of the image containing the neural network's predictions (e.g. presence or absence of a feature of a part) can still be seen through the translucent image highlight.

In accordance with yet another aspect, the at least one image is visible on a user interface with infinite scroll. In an embodiment, in this configuration, the user interface is in communication with the computer hardware in communication with the imaging device. In another embodiment, the user interface is in communication with a digital storage medium with at least one image, in which the digital storage medium is integral to the computer hardware of the system.

In accordance with yet another aspect, a graph of training error versus time is displayable on the user interface during the training of the at least one image recognition neural network.

In accordance with yet another aspect, a history of the at least one image is searchable on the user interface. Parameters that are searchable may include time, part, and AI confidence.

In accordance with yet another aspect, when the system makes a determination regarding the contents of the at least one image, the confidence threshold that the determination is correct is changeable by the user.

In accordance with yet another aspect, the at least one image recognition neural network comprises at least one convolutional neural network that is trained to identify the contents of the at least one image. The convolutional neural network takes as input a 2D matrix of pixel values representing an image, in which this 2D dimensionality is preserved as the network performs image recognition. The input to the at least one neural network is a data structure of image pixel values, and the output of the at least one neural network is a data structure with data representing a determination made based on the contents of the image, for instance, the recognition of an area of interest. Images that are uploaded are converted to inputs for the neural network, with the outputs being contrasted to the correct image label. If neural network output differs from the correct image label, the neural network is updated to perform better on subsequent images.

In an embodiment, the system may be used for inspecting the surface of steel for scratches and burrs. In another embodiment, the system may be used for inspecting cast metal part for imperfections. In another embodiment, the system may be used for inspecting laser welds for weld non-conformities. In another embodiment, the system may be used for ensuring that a printed circuit board (PCB) assembly has all its parts. In another embodiment, the system may be used for ensuring that gears are machined correctly. In another embodiment, the system may be used for inspecting aircraft engines. In another embodiment, the system may be used for inspecting auto engines. In another embodiment, the system may be used for barcode inspection and data matrix inspection. In another embodiment, the system may be used for part identification, barcode identification, and data matrix identification. In another embodiment, the system may be used for classifying parts. Essentially, the system may be used for any manufacturing, engineering, industrial, and logistical inspection process.

The imaging device may be selected from a number of devices, in which the imaging device may be decoupled from the overall system. In an embodiment, the system is connected to an imaging device over a local wired network. In another embodiment, the imaging device may be a Gig-E camera. In another embodiment, the imaging device may comprise a multiple of Gig-E cameras, namely more than one Gig-E camera. In another embodiment, the imaging device is a camera. In another embodiment, the imaging device is an augmented reality device. In another embodiment, the imaging device reports a 3D point cloud, which represents distance of objects in the image device field of view from the image device. In another embodiment, the imaging device is a virtual reality device. In another embodiment, the imaging device is a computer with a built-in camera. In another embodiment, the imaging device is a computer connected to an external camera. In another embodiment, the imaging device is a smartphone with a built-in camera.

The system may operate on multiple imaging devices in parallel. One embodiment is multiple Gig-E cameras connected to the system. Another embodiment is multiple cameras connected to the system.

The at least one image may be uploaded to the system by one click. In an embodiment, the click may be the mouse of a computer. In another embodiment, the click may be a button on the camera. In another embodiment, the click may be a button on a smartphone. In another embodiment, the click may be a button on an augmented reality device. In another embodiment, the click may be a button on a virtual reality device.

These and other features, aspects and advantages of the present teachings will become better understood with reference to the following description, examples and appended claims.

### DRAWINGS

Those of skill in the art will understand that the drawings, described below, are for illustrative purposes only. The drawings are not intended to limit the scope of the present teachings in any way.

FIG. 1. Flowchart of the system.

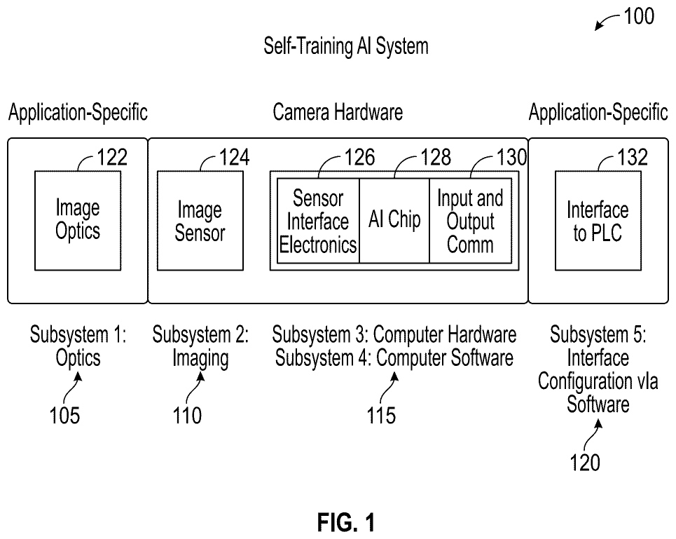

FIG. 2. Flowchart of the system as it relates to the part inspection process.

FIG. 3. Flowchart of the system during part inspection.

FIG. 4. Flowchart of the system in not during part inspection.

### DETAILED DESCRIPTION

### Abbreviations and Definitions

To facilitate understanding of the invention, a number of terms and abbreviations as used herein are defined below as follows:

Part: as used herein, the term “part” refers to any object under inspection as part of a manufacturing, engineering, industrial, or logistics process, for example vehicle components, household appliances, shipment boxes, and electronic goods, all of which may be inspected as part of a manufacturing, engineering, industrial or logistics process.

Imaging device: As used herein, the term “imaging device” refers to any mechanical, digital, or electronic viewing instrument capable of recording, storing, or transmitting visual images. These images may be two-dimensional (2D) or three-dimensional (3D) images of parts. 2D refers to a visual representation based on width and height of imaging device field of view. 3D refers to a visual representation based on width and height of imaging device field of view, with the third dimension representing distance from image sensor to object. 2D and 3D images as referenced herein may additionally have a color dimension in which the 2D or 3D image is represented in one of monochrome or multichrome (red, green, and blue). 2D and 3D images may be captured through one of passive photon reception or active photon generation with subsequent photon reception. In the case of 2D images converted to 3D absent of active photon generation, image post-processing can infer the depth dimension.

Onboard: As used herein, the term “onboard” refers to denoting or controlled from a facility or feature incorporated into the hardware of the system.

Image: As used herein, the term “image” may refer either to a 2D representation of a part from an imaging device, or a 3D representation of a part from an imaging device, in which the third dimension is object distance from image sensor.

Neural Network: As used herein, the term “neural network” refers to a digital data structure with learnable weights, in which the computer's representation is learned rather than explicitly programmed. The details of learning algorithm and details of the data structure architecture may vary. Examples of a neural network may include a convolution neural network, recurrent neural network, transformer, or other neural network architecture, and the learning algorithm may entail one of supervised learning, unsupervised learning, or reinforcement learning.

Trained: As used herein, the term “trained” refers to having been taught a particular skill or type of behavior through practice and instruction over a period of time.

In real time: As used herein, the term “in real time” refers to input data being processed within milliseconds so that it is available virtually immediately as feedback.

Infinite scroll: As used herein, the term “infinite scroll” refers to a technique that loads content continuously as the user scrolls down the page, eliminating the need for pagination.

Systems and Methods for Inspecting Parts

The present invention is directed to a system 100 comprising a few subsystems. Subsystem #1 105 comprises image optics 122, or the lens of an imaging device. In this embodiment, the imaging device is a camera, but the imaging device may be other devices capable of capturing images. The camera hardware comprises Subsystem #2 110 and Subsystems #3 and #4 115. Subsystem #2 110 comprises an image sensor 124 that detects images being captured by the system 100 by converting light to an image. Subsystem #3 and #4 115 comprises the hardware and software that the imaging device uses. Sensor interface electronics 126 and an AI chip 128 comprises the computer hardware, while input and output communication 130 comprises the computer software. Sensor interface electronics 126 provide digital input to the computer hardware, while the AI chip 128 acts as the hardware running an image recognition neural network. In another embodiment, the AI chip 128 may run more than one image recognition neural network. Subsystem #5 120 comprises an interface to the programmable logic controller (PLC) 132, which acts as a connection between the system 100 and, for instance, a production line that presents parts to the system 100 for part inspection.

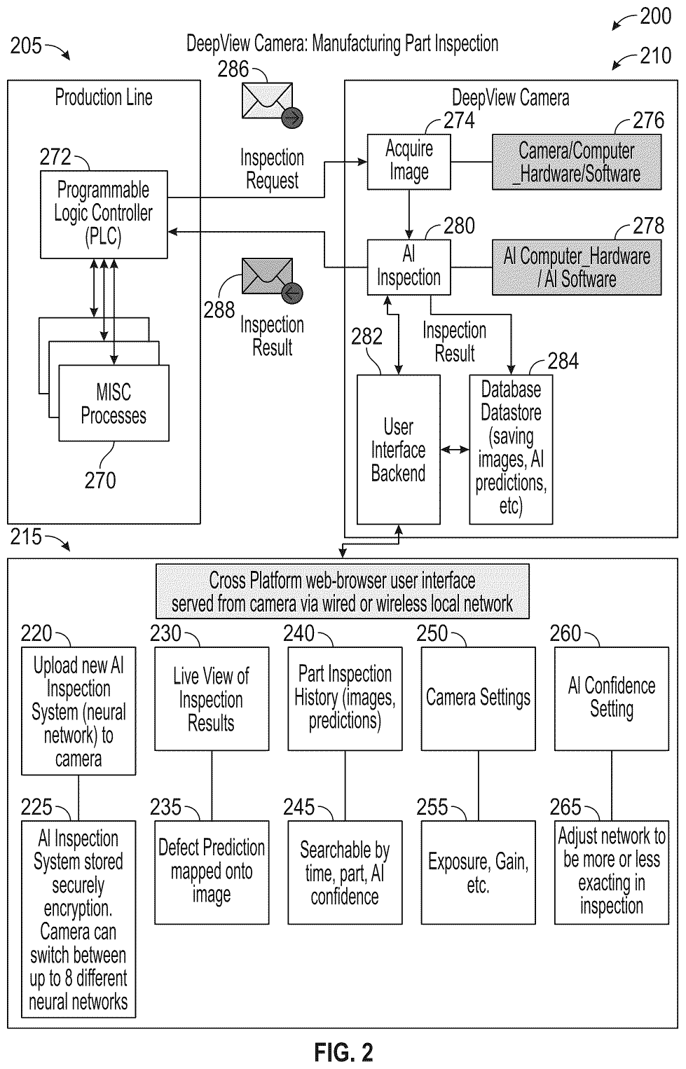

FIG. 2 shows the manufacturing part inspection process 200, featuring a production line 205, an imaging device 210 (a camera in this embodiment), and a user interface 215 (web browser in this embodiment). The production line 205 comprises miscellaneous processes 270 working in tandem with a digital communications device 272 (PLC in this embodiment). Miscellaneous processes 270 refer to operations unrelated to part inspection but also controlled by the digital communications device 272 (PLC in this embodiment). The digital communications device 272 may trigger an inspection request 286 by which the imaging device 210 acquires an image 274 with the imaging device's hardware and software 276 and inspects the image 280, the inspection results being processed by the computer hardware of the system 282 and stored in a database 284 onboard the system. The inspection results are then forwarded to the digital communications device 272. The inspection results may be optionally shown on the user interface 215. Additionally, the system may receive an inspection request from a device other than a PLC, and report results to a device other than a PLC. For example, the camera may receive inspection requests and report inspection results from a computer over a local network. The inspection results that appear on the user interface 215 may be served via wired or wireless network from the imaging device 210. Several parameters or features of the system 100 may be shown on the user interface 215. One of them is the selection of a new image recognition neural network to run during the inspection process. This selection may be made from a list of neural networks stored on the system. The user may also add to or delete from the list of available neural networks stored on the system. The number of neural networks stored on the system may be at least 8. Additionally the digital communications device 272 may send a request to the system to change the active neural network from the list of networks, for example to run a different inspection process. Another parameter is live view of inspection results 230, with neural network inspection prediction mapped right onto an image 235. Part inspection history 240 is another feature available for view with the user interface 215. The history may be searchable by time, part, and confidence 245. Camera settings 250 may also be viewable and changeable on the user interface 215 with camera exposure, camera gain, and network communication settings examples 255 settings that may be changed. Confidence settings 260 may also be shown on the user interface 215, with adjustments of the confidence settings threshold for inspection reporting 265 possible to make more accurate predictions: the user may be able to set a confidence threshold in which, for example any neural network prediction made with confidence less than the threshold could be reported as failing the inspection process.

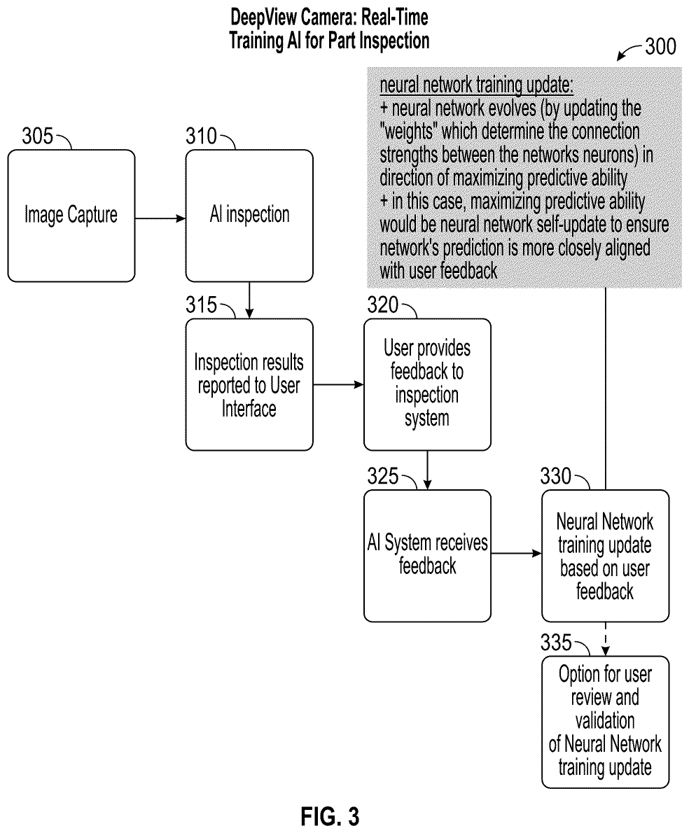

FIG. 3 is a flowchart showing the part inspection process in real time 300. Image capture 305 is followed by inspection of the image 310. Inspection results reported to the user interface 315 is next, after which the user provides feedback to the system 320. The system receives the user feedback 325, followed by a neural network training update based on the user feedback 330, with the option of a user review and validation of the neural network training update 335.

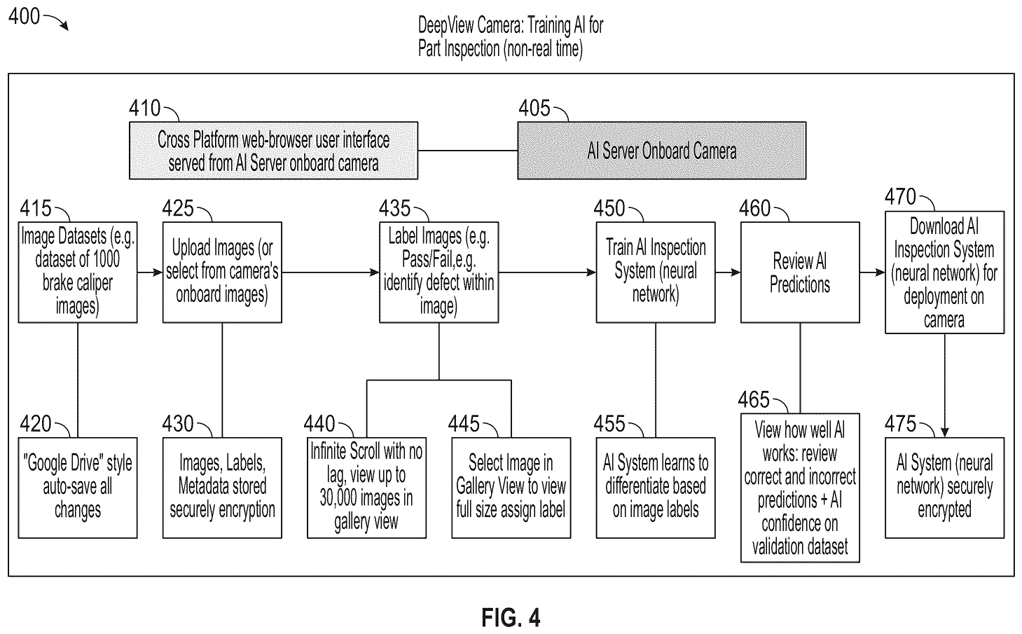

FIG. 4 shows a flowchart of the part inspection process in non-real time 400. A server onboard computer hardware integral to an imaging device 405 (a camera in this embodiment) is in communication with a user interface 410. Image datasets 415 are taken by the imaging device, with the imaging device auto saving all changes 420. Next is uploading images or selecting images onboard the computer hardware integrated with the imaging device 425, with images, image labels, and metadata stored securely 430. Labelling images 435 is next; with infinite scroll of images 440 and images selectable in gallery view 445. In one embodiment, labelling images 435 may result in a go/no go decision. In another embodiment, labelling images 435 may result in a pass/fail decision. In another embodiment, labelling images 435 may result in the identification of one of a defect or non-conformity. In another embodiment, labelling images 435 may result in the identification of a barcode or a data matrix. Next is training the image recognition neural network 450, with the system learning to differentiate based on image labels 455. The process then reviews predictions of the image recognition neural network 460, accompanied with the review of correct and incorrect predictions 465. Validation of the image datasets may also be executed in this step. Reviewing predictions of the image recognition neural network 460 is followed by deployment of the image recognition neural network on the computer hardware of the system, with the image recognition neural network optionally securely encrypted 475.

### Other Embodiments

The detailed description set-forth above is provided to aid those skilled in the art in practicing the present invention. However, the invention described and claimed herein is not to be limited in scope by the specific embodiments herein disclosed because these embodiments are intended as illustration of several aspects of the invention. Any equivalent embodiments are intended to be within the scope of this invention. Indeed, various modifications of the invention in addition to those shown and described herein will become apparent to those skilled in the art from the foregoing description which do not depart from the spirit or scope of the present inventive discovery. Such modifications are also intended to fall within the scope of the appended claims.

What is claimed is:

1. A system for performing a visual inspection of a part as part of one of a manufacturing, engineering, logistical, and industrial process, the system comprising:
an imaging device;
computer hardware in communication with the imaging device;
computer software executed by the computer hardware; and
at least one image recognition neural network, with the at least one image recognition neural network configured to train onboard the computer hardware.

2. The system of claim 1, wherein the system stores at least one image and at least one image label.

3. The system of claim 2, further comprising a user interface.

4. The system of claim 3, further comprising a digital communication device, with the digital communication device being at least one of a Programmable Logic Controller (PLC), a local server, and an internet server.

5. The system of claim 3, wherein the user interface allows manipulation of the at least one image and the at least one image label.

6. The system of claim 1, wherein the at least one image recognition neural network may be trained in at least one of during part inspection and not during part inspection

7. The system of claim 2, wherein the at least one image, the at least one image recognition neural network, and the at least one label are stored onboard the computer hardware.

8. The system of claim 2, wherein a user may inspect the at least one image and make a determination regarding the at least one image.

9. The system of claim 8, wherein the system uses feedback from the user to train the at least one image recognition neural network on the at least one image.

10. A method for training an image recognition neural network during part inspection comprising:
capturing at least one image with an imaging device;
inspecting the at least one image with at least one image recognition neural network;
reporting inspection results to a user interface;
via the user interface, soliciting user feedback based on at least one of contents of the at least one image and inspection results;
receiving the user feedback;
updating internal weights of the at least one image recognition neural network based on the user feedback (i.e. training the network directly from the data received from the users' feedback); and
optionally reviewing and validating an image recognition neural network weight update that occurs based on at least one of solicitation of the system and receipt of user feedback.

11. A method for training an image recognition neural network onboard a system comprising:
selecting at least one image used to train the image recognition neural network by at least one of uploading the at least one image and selecting the at least one image from a group of images stored onboard a system via a user interface;
optionally identifying an area of interest within the at least one image;
soliciting a user to apply at least one label to the at least one image via the user interface;
splitting the at least one image and the at least one label into at least one of a training subset comprised of images and image labels and a test subset comprised of images and image labels;
soliciting neural network training parameters from the user via the user interface;
from the least one image provided by the user and the at least one label comprising the training subset and neural network training settings, updating neural network weights based on contents of the training subset;
via the user interface, allowing the user to monitor neural network training progress as it occurs, displaying relevant training statistics on the user interface, with the training statistics being a reflection of how well the image recognition neural network is performing on the test subset; and
following the neural network training, displaying via the user interface results of the neural network training on the test subset of images and labels and displaying to the user predictions of the image recognition neural network of the test subset, including confidence scores ranging from 0 to 100%.

12. The method of claim 10, wherein the method is a part of an inspection process.

13. The method of claim 10, wherein the contents of the at least one image is at least one of an imperfection, a non-conformity, a barcode, and data matrix.

14. The method of claim 13, wherein a neural network prediction of the contents of the at least one image is mapped onto the at least one image, with the neural network prediction being visualized as at least one of a two-dimensional box, a three-dimensional box, and a translucent color that highlights the neural network prediction.

15. The method of claim 10, wherein the at least one image is visible on a user interface with infinite scroll.

16. The method of claim 15, wherein a graph of training error versus time is displayed on the user interface during training of the image recognition neural network.

17. The method of claim 15, wherein a history of the at least one image is searchable on the user interface.

18. The method of claim 10, wherein a confidence threshold to make a determination regarding the contents of the at least one image is user changeable.

19. The method of claim 10, wherein the image recognition neural network comprises at least one convolutional neural network trained for at least one of identifying the contents of the at least one image and making a determination based on the contents of the at least one image.

20. The system of claim 1, wherein the imaging device is decoupled from the system, with the imaging device comprising a Gig-E camera and the Gig-E camera being connected to the system over a wired connection.

21. The system of claim 1, wherein the imaging device may comprise a multiple of imaging devices, processing at least one image in parallel.
